(19) United States
(12) Patent Application Publication
(10) Pub. No.: US 2013/0324441 A1
(43) Pub. Date: Dec. 5, 2013

(54) Drilling Fluids Useful For Limiting Tar Sand Accretion

(71) Applicant: Ioan Ghesner, Calgary (CA)

(72) Inventor: Ioan Ghesner, Calgary (CA)

(73) Assignee: Diversity Technologies Corporation, Edmonton (CA)

(21) Appl. No.: 13/909,161

(22) Filed: Jun. 4, 2013

(30) Foreign Application Priority Data
Jun. 4, 2012 (CA) 2779190

(51) Int. Cl. C09K 8/12

(52) U.S. Cl. CPC C09K 8/12
USPC 507/111; 507/120; 507/123; 507/117; 507/121; 507/114; 507/113; 507/115; 507/110

(57) ABSTRACT

A drilling fluid is provided that comprises a non-ionic or cationic polymer having general formula I or II. The drilling fluid may be used in drilling or other oilfield operations to prevent or limit the accretion of hydrocarbons to metal components when these are in contact with highly viscous hydrocarbons such as those present in formations containing heavy crude oil or tar sand.

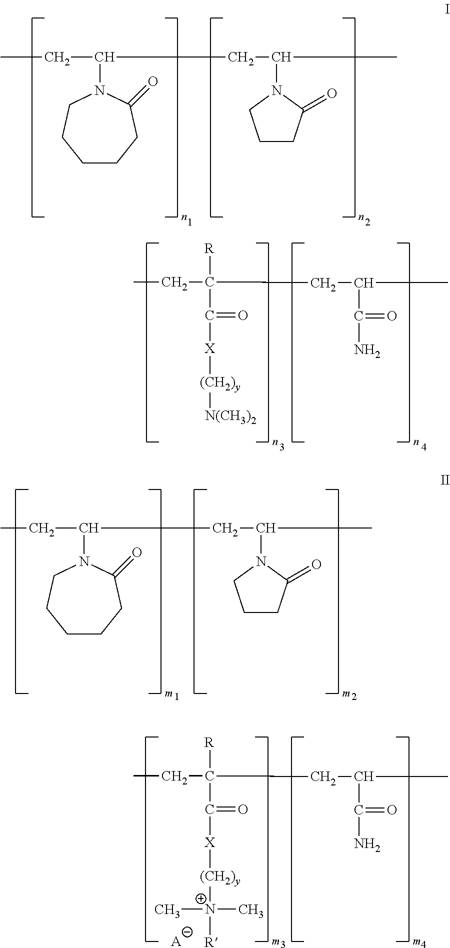

### CROSS REFERENCE TO RELATED APPLICATION

This application claims priority under the Paris Convention to Canadian application no. 2,779,190, filed on Jun. 4, 2012, the contents of which are incorporated herein by reference.

### FIELD OF THE INVENTION

The present invention relates to drilling fluids and specifically a drilling fluid that contains a polymer additive. The drilling fluid may be suitable for drilling through formations that contain heavy crude oil, tar sand and other sources of highly viscous hydrocarbons.

### BACKGROUND OF THE INVENTION

Water-based drilling fluids that contain solvents or wetting agents that are intended to limit bitumen accretion to metal surfaces are described in Canadian patents 2454312, 2481543, 2451585 and 2437522. These solvent and/or surfactant systems rely on the solvent's ability to dissolve bitumen. This approach limits the number of wells that can be drilled before the drilling fluid must be stripped of the built-up bitumen.

More recent anti-accretion drilling fluid additives reported in the patent literature consist of polymers such as non-ionic, anionic, cationic and hydrophobically associating polymers. These polymer additives are believed to prevent accretion of the bitumen or heavy oil to metal surfaces via an encapsulation mechanism that involves the formation of an ion pair between the cationic functionalities on the encapsulating polymer and the negative charges found in the composition of bitumen. This mechanism is supported by the experimental observation that polymers with increasing cationic charge provide the best encapsulating and anti-accretion properties. Encapsulator-type systems are described in Canadian patents 2508339, 2624834 and 2635300.

Certain drilling fluids of the prior art that include a cationic polymer have the disadvantage that they can be incompatible with other drilling fluid additives used as viscosifiers. More specifically, the cationic polymer can coagulate polymers added as viscosifiers and decrease the overall viscosity and carrying capacity of the drilling fluid. This is particularly problematic in horizontal wells such as those drilled in SAGD operations.

In addition, certain drilling fluids of the prior art that contain a non-ionic polymer do not perform well in certain formations and may not prevent accretion on drilling equipment to a satisfactory degree.

### SUMMARY OF THE INVENTION

An object of the present invention is to provide an improved drilling fluid that contains a polymer-based additive that limits accretion of heavy oil, bitumen and other highly viscous hydrocarbons onto metal surfaces such as steel drill bits and other drilling equipment. The polymer may be non-ionic or cationic.

In accordance with one aspect of the present invention there is provided a water-based drilling fluid that comprises a non-ionic and/or cationic polymer, wherein the polymer has functional groups that permit it to limit accretion of bitumen or heavy oil to drilling components during a drilling process to an acceptable amount, when the polymer is incorporated into a drilling fluid. Preferably, the polymer comprises amide or lactam (cyclic amide) functional groups.

According to one aspect, the invention relates to a drilling fluid that comprises a non-ionic polymer of the following general formula I:

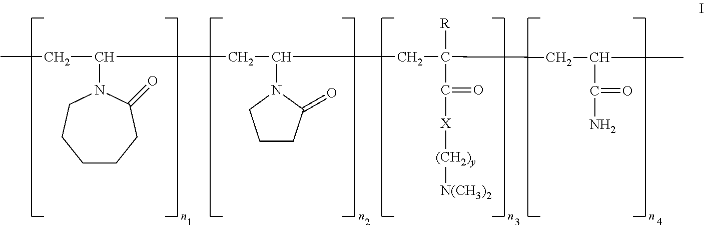

wherein:

R is hydrogen or an alkyl group optionally containing at least one heteroatom comprising oxygen or nitrogen; n₁, n₂, n₃ and n₄ each independently range from 0 to 1,000,000 and at least one of n₁, n₂, n₃ and n₄ has a value greater than zero; X comprises nitrogen or oxygen; and y is 2 or 3.

According to another aspect, the polymer is a cationic polymer having the following general formula II:

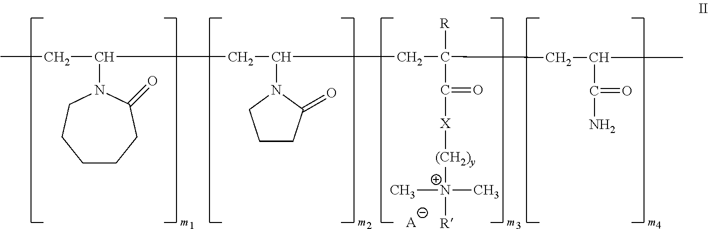

wherein:

R is as defined above; m₁, m₂, m₃ and m₄ each independently range from 0 to 1,000,000 and at least one of m₁, m₂, m₃, and m₄ has a value greater than zero; X comprises nitrogen or oxygen; and y is 2 or 3; R′ is the same as R or different and is hydrogen or a linear, branched, saturated, unsaturated or cyclic alkyl group optionally containing at least one heteroatom comprising oxygen or nitrogen; and A is chloride, bromide, sulfate, methyl sulfate or ethyl sulfate.

The alkyl group in R and R′ may be a C₁-C₁₂, C₁ to C₆ or a C₁ to C₃ alkyl.

According to another aspect, the invention relates to a cationic polymer of the following formula III:

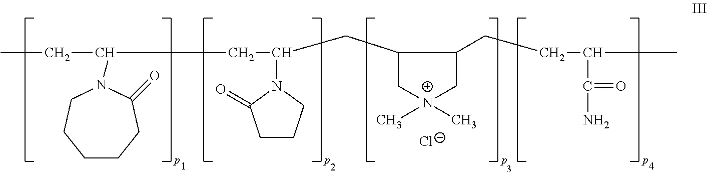

wherein:

p₁, p₂, p₃ and p₄ each independently range from 0 to 1,000,000 and at least one of p₁, p₂, p₃ and p₄ has a value greater than zero.

The water base of the drilling fluid may comprise one or more of fresh water, brine, or a water soluble compound.

The pH of the drilling fluid may range from about 1 to about 13 and more specifically may be pH 4 to 11.

In yet another aspect, the drilling fluid further comprises one or more of a viscosifier, shale swelling inhibitor, fluid loss additive, defoamer, bactericide, lost circulation material or a weighting material (“additional drilling fluid components”).

Another aspect of the invention relates to a mix or pre-mix kit of components for preparing a drilling fluid, comprising the polymer of the present invention as described herein and one or more additional drilling fluid components such as described herein.

The invention further relates to a use of the polymer of the present invention as described herein in a drilling fluid. The invention further relates to a method of preparing a drilling fluid, by combining a polymer of the present invention as described herein with an aqueous phase and optionally one or more additional drilling fluid components as described herein.

The invention further relates to a method of drilling into a formation that contains bitumen, heavy oil, oil sand or other highly viscous or accretion-tending hydrocarbon, by circulating a drilling fluid in the well that contains the polymer of the present invention as described herein and optionally one or more additional drilling fluid components as described herein. The drilling fluid may be circulated at any stage during drilling or post-drilling operations.

According to another aspect, a drilling fluid according to the invention limits accretion of bitumen, heavy oil and the like on metal drilling tools to an acceptable level when used in a drilling operation.

The term “alkyl” as used herein includes saturated and unsaturated alkyl groups, and optionally having one or more heteroatoms consisting of oxygen or nitrogen. The alkyl group may, where sufficient carbon or heteroatoms are present, be linear, branched or cyclic, and may comprise a C₁-C₃, C₁-C₆ or C₁-C₁₂ alkyl.

### DETAILED DESCRIPTION

The polymer for use in the drilling fluid according to the present invention may comprise the polymer of Formula I, II or III as defined above.

In one aspect, the non-ionic polymer may be a homopolymer or heteropolymer of one or more of vinylpyrrolidone, vinylcaprolactam, acrylate or acrylamide. The acrylate monomer may be dimethylaminoethyl acrylate, dimethylaminoethyl methacrylate, methyl acrylate, methyl methacrylate, hydroxyethyl acrylate or hydroxyethyl methacrylate. The acrylamide monomer may be acrylamide, dimethylaminopropyl acrylamide or dimethylaminopropyl methacrylamide.

The cationic polymer may be a homopolymer or heteropolymer of one or more of acrylate, acrylamide and diallyldimethylammonium chloride with vinylpyrolidone and/or vinylcaprolactam monomers.

The acrylate monomers may be selected from dimethylaminoethyl acrylate methyl chloride salt, dimethylaminoethyl acrylate benzyl chloride salt, dimethylaminoethyl acrylate methyl sulfate salt, dimethylaminoethyl acrylate ethylsulfate salt, dimethylaminoethyl acrylate sulfuric acid salt, dimethylaminoethyl acrylate hydrochloric acid salt, dimethylaminoethyl acrylate sulphamic acid salt, dimethylaminoethyl acrylate citric acid salt, dimethylaminoethyl methacrylate methyl chloride salt, dimethylaminoethyl methacrylate benzyl chloride salt, dimethylaminoethyl methacrylate methyl sulfate salt, dimethylaminoethyl methacrylate ethylsulfate salt, dimethylaminoethyl methacrylate sulfuric acid salt, dimethylaminoethyl methacrylate hydrochloric acid salt, dimethylaminoethyl methacrylate sulphamic acid salt or dimethylaminoethyl methacrylate citric acid salt.

The acrylamide monomer may be acrylamide, dimethylaminopropyl acrylamide methyl chloride salt, dimethylaminopropyl acrylamide benzyl chloride salt, dimethylaminopropyl acrylamide methyl sulfate salt, dimethylaminopropyl acrylamide ethyl sulfate salt, dimethylaminopropyl acrylamide sulfuric acid salt, dimethylaminopropyl acrylamide hydrochloric acid salt, dimethylaminopropyl acrylamide sulphamic acid salt, dimethylaminopropyl acrylamide citric acid salt, dimethylaminopropyl methacrylamide methyl chloride salt, dimethylaminopropyl methacrylamide benzyl chloride salt, dimethylaminipropyl methacrylamide methyl sulfate salt, dimethylaminopropyl methacrylamide ethyl sulfate salt, dimethylaminopropyl methacrylamide sulfuric acid salt, dimethylaminopropyl methacrylamide hydrochloric acid salt, dimethylaminopropyl methacrylamide sulphamic acid salt or dimethylaminopropyl methacrylamide citric acid salt.

The drilling fluid has a concentration of the encapsulating polymer sufficient to inhibit the accretion of bitumen to exposed metal surfaces. The concentration of the polymer may be up to about 20% by weight of the drilling fluid. In one aspect, the polymer is present at 0.005% to 1% w/w. The pH of the drilling fluid may range from about 1 to about 13. In one aspect, the pH of the drilling fluid ranges between pH 4 and pH 11.

The drilling fluid may comprise one or more additives such as a viscosifier, fluid loss additive, weighting agent, clay control additive or a bridging agent.

The viscosifier may be xanthan gum, guar gum, hydroxyethyl cellulose, carboxymethyl cellulose, hydroxypropyl guar gum, hydroxypropyl carboxymethyl guar gum, locust bean gum, starch. The fluid loss additive may be selected from carboxymethyl cellulose, derivatized starch, or carboxymethyl guar.

The drilling fluid may alternatively comprise essentially a water base and the polymer described herein without the addition of a viscosifier or fluid loss additive. The water base of the drilling fluid may comprise fresh water, brine, a water soluble compound, or any combination or mixture thereof.

In yet another aspect of the invention, a pre-mix is provided for preparing a drilling fluid, consisting of the polymer as described herein and one or more additional drilling fluid components. The additional component(s) may consist of one or more of a viscosifier, fluid loss additive, shale swelling inhibitor, defoamer, bactericide, lost circulation material, weighting agent, clay control additive, or a bridging agent.

### Example 1

In representative examples, the drilling fluid comprises:

a) 6 kg/m³ guar gum and 2 kg/m³ polyvinylpyrolidone hydrated in water;
b) 0.8 kg/m³ xanthan gum, 3.2 kg/m³ guar gum and 2 kg/m³ copolymer of vinylpyrrolidone and dimethylaminopropylmethacrylamide hydrated in water;
c) 4 kg/m³ guar gum, 4 kg/m³ carboxymethyl starch and 2 kg/m³ copolymer of vinylcaprolactam and dimethylaminopropylmethacrylamide hydrochloric acid salt hydrated in water;
d) 0.8 kg/m³ xanthan gum, 3.2 kg/m³ guar gum, 4 kg/m³ polyanionic cellulose and 2 kg/m³ terpolymer of vinylpyrolidone, dimethylaminopropylmethacrylate and methacrylamidopropyl lauryl dimethyl ammonium chloride hydrated in water.

### Example 2

### Preparation of Drilling Fluid

To tap water were added 2 kg/m³ xanthan gum, 4 kg/m³ carboxymethyl starch and 1-5 kg/m³ polymer of the type described below. The polymer and other dry constituents were hydrated in water for 30 minutes using a Hamilton Beach blender to prepare the drilling fluid of Example 2. Afterwards, tar sand was added at a loading of 25 to 30% wt/vol and the mixture further mixed in the blender for an additional 3 minutes. A control sample was prepared as described above but without the addition of the polymer.

### Example 3

### Testing of Drilling Fluid Comprising Polymers

To test the anti-accretion properties of the drilling fluid a steel rod having a diameter of 3 cm and length of 7 cm was rolled for defined duration in a mixture of the drilling fluid as prepared in example 2 above. The steel rod simulates a down hole drilling assembly. The steel rod was immersed in a rolling cell filled with the drilling fluid and bitumen mixture to be tested. The bitumen mixture consisted of 28% bitumen and 72% of a sand and clay mixture. The cells were then rolled for 16 hours at ambient temperature. The drilling fluid was considered effective (“pass”) in preventing accretion of bitumen to metal surfaces if at the end of the 16 hours rolling time the steel rod was not visibly coated with bitumen. A drilling fluid considered ineffective (“fail”) if the rod was visibly coated.

Non-ionic polymers tested in example 3 were: NE-1, a polyvinylpyrrolidone homopolymer with a molecular weight of 1,300,000 g/mol; NE-2, a copolymer of vinylpyrrolidone and dimethylaminopropylmethacrylamide with a molecular weight of about 2,000,000 g/mol; NE-3, a terpolymer of vinylpyrolidone, vinylcaprolactam and dimethylaminoethylmethacrylate with a molecular weight of 82,700.

Cationic polymers (CE) tested in example 3 were: CE-1, a vinylpyrrolidone/dimethylaminopropylmethacrylamide hydrochloric acid salt copolymer with molecular weight of about 2,000,000 g/mol; CE-2 a vinylpryrrolidone/vinylcaprolactam/dimethylaminoethylmethacrylate sulphamic acid salt terpolymer with molecular weight of about 83,000 g/mol; CE-3, a terpolymer of vinylpyrolidone/dimethylaminopropylmethacrylate/methacrylamidopropyl lauryl dimethyl ammonium chloride with a molecular weight of 2,700,000 g/mol.

TABLE 1
Bitumen anti-accretion rolling test results

| | Polymer | Tar sand | Drilling | |
|---|---|---|---|---|
| polymer | concentration | concentration | fluid pH | Pass/Fail |
| No polymer | — | 30% (w/v) | 10 | Fail |
| CE-1 | 2 kg/m³ | 30% (w/v) | 2 | Pass |
| CE-1 | 4 kg/m³ | 30% (w/v) | 2 | Pass |
| NE-1 | 2 kg/m³ | 30% (w/v) | 10 | Pass |
| NE-2 | 0.6 kg/m³ | 25% (w/v) | 9 | Pass |
| NE-2 | 1.8 kg/m³ | 30% (w/v) | 9 | Pass |
| CE-1 | 1.2 kg/m³ | 25% (w/v) | 5 | Pass |
| CE-2 | 1.8 kg/m³ | 25% (w/v) | 5 | Pass |
| NE-3 | 3 kg/m³ | 30% (w/v) | 9 | Pass |
| CE-3 | 3 kg/m³ | 30% (w/v) | 5 | Pass |

### Example 4

### Polymer/Viscosifier Interaction

Table 2 shows the results of tests conducted in order to determine the effect of the polymers on the viscosity of the drilling fluid. The viscosifiers used in the tests conducted were xanthan gum and carboxymethyl cellulose. The rheology of the drilling fluids was measured with a Fann 35A instrument. The plastic viscosity (PV) and the yield point (YP) of the drilling fluids were calculated from the 600 RPM and 300 RPM viscosity dial readings (D.R.).

TABLE 2
Rheology of drilling fluids containing polymer and viscosifier

| | 600 RPM | 300 RPM | PV | YP |
|---|---|---|---|---|
| | (D.R.) | (D.R.) | (mPas) | (Pa) |
| 2 kg/m³ Xanthan, 4 kg/m³ | 25 | 18 | 7 | 5.5 |
| carboxymethyl starch; pH = 10 | | | | |
| (no polymer) | | | | |
| 2 kg/m³ Xanthan, 4 kg/m³ | 30.5 | 21.5 | 9 | 6.25 |
| carboxymethyl starch, 4 kg/m³ | | | | |
| NE-1; pH = 10 | | | | |
| 2 kg/m³ Xanthan, 4 kg/m³ | 30 | 21.5 | 8.5 | 6.5 |
| carboxymethyl starch, 4 kg/m³ | | | | |
| NE-2; pH = 10 | | | | |
| 2 kg/m³ Xanthan, 4 kg/m³ | 31 | 21.5 | 9.5 | 6 |
| carboxymethyl starch, 4 kg/m³ | | | | |
| NE-3; pH = 10 | | | | |
| 2 kg/m³ Xanthan, 4 kg/m³ | 24.5 | 18 | 6.5 | 5.75 |
| carboxymethyl starch, 4 kg/m³ | | | | |
| CE-1; pH = 5 | | | | |
| 2 kg/m³ Xanthan, 4 kg/m³ | 23 | 17 | 6 | 5.5 |
| carboxymethyl starch, 4 kg/m³ | | | | |
| CE-2; pH = 5 | | | | |
| 2 kg/m³ Xanthan, 4 kg/m³ | 26.5 | 19 | 7.5 | 5.75 |
| carboxymethyl starch, 4 kg/m³ | | | | |
| CE-3; pH = 5 | | | | |

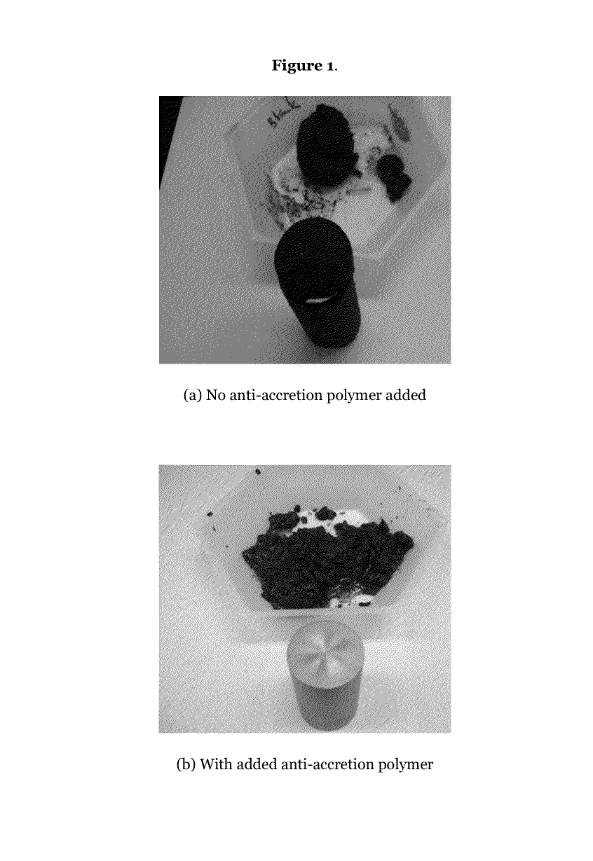

FIG. 1 shows the condition of the steel rods after rolling continuously for 16 hours with 30% w/v tar sand in the absence (FIG. 1a) and in the presence (FIG. 1b) of the polymers tested as described above.

As can be seen in FIG. 1, in the absence of the polymer the steel rod is covered with a thick layer of bitumen. The addition of the polymer has prevented bitumen accretion.

In comparative tests against other prior art products, it was found that certain prior art cationic polymers that preventing accretion of bitumen when incorporated into a drilling fluid adversely affect the viscosity of the drilling fluid. Non-ionic polymers of prior art that were tested do not adversely affect the viscosity of the drilling fluid but are not as good at preventing accretion of bitumen as the cationic polymers. The present invention thus provides a drilling fluid that in at least certain embodiments overcomes one or both of these drawbacks of the prior art.

All documents referred to herein are incorporated into this patent specification by reference.

The scope of the claims should not be limited by the preferred embodiments set forth in the examples, but should be given the broadest interpretation consistent with the description as a whole. The claims are not to be limited to the preferred or exemplified embodiments of the invention.

1. A drilling fluid comprising at least one polymer comprising a non-ionic polymer, a cationic polymer, or a mixture thereof, wherein the polymer comprises monomers comprising at least one of an amide or lactam functional group; and an aqueous phase.

2. The drilling fluid of claim 1 wherein said non-ionic polymer has the general formula I: 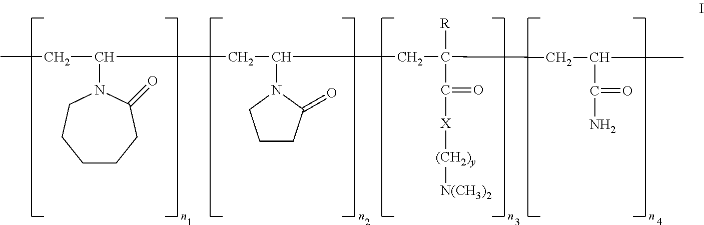
Wherein:
R is hydrogen or an alkyl group optionally containing at least one heteroatom comprising oxygen or nitrogen, wherein said alky group is saturated or unsaturated, and is linear, branched or cyclic as permitted by the length of said group;
n₁, n₂, n₃ and n₄ are each independently selected from 0 to 1,000,000 and at least one of n₁, n₂, n₃ and n₄ has a value greater than zero;
X is nitrogen or oxygen; and
y is 2 or 3.

3. The drilling fluid of claim 2 wherein said alkyl group is a C₁ to C₁₂, C₁ to C₆ or C₁ to C₃ alkyl group.

4. The drilling fluid of claim 1 wherein said cationic polymer has the general formula II: 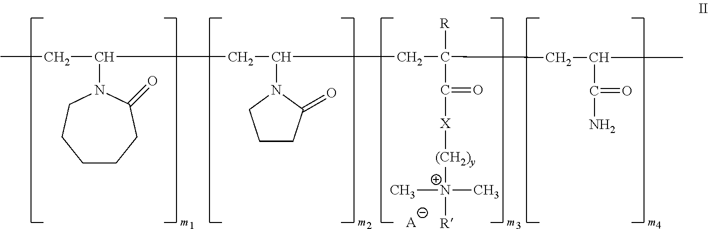
wherein:
R and R′ are independently hydrogen or an alkyl group optionally containing at least one heteroatom comprising oxygen or nitrogen, wherein said alky group is saturated or unsaturated, and is linear, branched or cyclic as permitted by the length of said group;
m₁, m₂, m₃ and m₄ are each independently selected from 0 to 1,000,000 and at least one of m₁, m₂, m₃ and m₄ has a value greater than zero;
X comprises nitrogen or oxygen;
y is 2 or 3; and
A is chloride, bromide, sulfate, methyl sulfate or ethyl sulfate.

5. The drilling fluid of claim 4 wherein said alkyl group is a C₁ to C₁₂, C₁ to C₆ or C₁ to C₃ alkyl group.

6. The drilling fluid of claim 1 wherein said cationic polymer has the formula III: 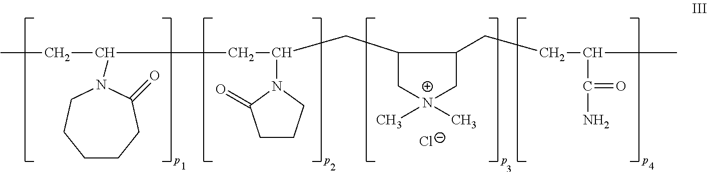
wherein:
p₁, p₂, p₃, p₄ are each independently selected from 0 to 1,000,000 and at least one of p₁, p₂, p₃ and p₄ has a value greater than zero.

7. The drilling fluid of claim 1 wherein said polymer comprises: a polyvinylpyrrolidone homopolymer, a copolymer of vinylpyrrolidone and dimethylaminopropylmethacrylamide, a terpolymer of vinylpyrolidone, vinylcaprolactam and dimethylaminoethylmethacrylate, a vinylpyrrolidone/dimethylaminopropylmethacrylamide hydrochloric acid salt copolymer, a vinylpryrrolidone/vinylcaprolactam/dimethylaminoethylmethacrylate sulphamic acid salt terpolymer, or a terpolymer of vinylpyrolidone/dimethylaminopropylmethacrylate/methacrylamidopropyl lauryl dimethyl ammonium chloride.

8. The drilling fluid of claim 1 wherein said non-ionic polymer comprises a homopolymer of vinylpyrrolidone, vinylcaprolactam, acrylate or acrylamide monomers; or a heteropolymer of two or more of vinylpyrrolidone, vinylcaprolactam, acrylate or acrylamide monomers.

9. The drilling fluid of claim 8 wherein said acrylate comprises dimethylaminoethyl acrylate, dimethylaminoethyl methacrylate, methyl acrylate, methyl methacrylate, hydroxyethyl acrylate or hydroxyethyl methacrylate.

10. The drilling fluid of claim 8 wherein said acrylamide comprises acrylamide, dimethylaminopropyl acrylamide or dimethylaminopropyl methacrylamide.

11. The drilling fluid of claim 1 wherein said cationic polymer comprises a homopolymer of acrylate, acrylamide, diallyldimethylammonium chloride, vinylpyrolidone or vinylcaprolactam monomers; or a heteropolymer of two or more of acrylate, acrylamide, diallyldimethylammonium chloride, vinylpyrolidone or vinylcaprolactam monomers.

12. The drilling fluid of claim 11 wherein said acrylate monomer is dimethylaminoethyl acrylate methyl chloride salt, dimethylaminoethyl acrylate benzyl chloride salt, dimethylaminoethyl acrylate methyl sulfate salt, dimethylaminoethyl acrylate ethylsulfate salt, dimethylaminoethyl acrylate sulfuric acid salt, dimethylaminoethyl acrylate hydrochloric acid salt, dimethylaminoethyl acrylate sulphamic acid salt, dimethylaminoethyl acrylate citric acid salt, dimethylaminoethyl methacrylate methyl chloride salt, dimethylaminoethyl methacrylate benzyl chloride salt, dimethylaminoethyl methacrylate methyl sulfate salt, dimethylaminoethyl methacrylate ethylsulfate salt, dimethylaminoethyl methacrylate sulfuric acid salt, dimethylaminoethyl methacrylate hydrochloric acid salt, dimethylaminoethyl methacrylate sulphamic acid salt, or dimethylaminoethyl methacrylate citric acid salt.

13. The drilling fluid of claim 11 wherein said acrylamide monomer is acrylamide, dimethylaminopropyl acrylamide methyl chloride salt, dimethylaminopropyl acrylamide benzyl chloride salt, dimethylaminopropyl acrylamide methyl sulfate salt, dimethylaminopropyl acrylamide ethyl sulfate salt, dimethylaminopropyl acrylamide sulfuric acid salt, dimethylaminopropyl acrylamide hydrochloric acid salt, dimethylaminopropyl acrylamide sulphamic acid salt, dimethylaminopropyl acrylamide citric acid salt, dimethylaminopropyl methacrylamide methyl chloride salt, dimethylaminopropyl methacrylamide benzyl chloride salt, dimethylaminipropyl methacrylamide methyl sulfate salt, dimethylaminopropyl methacrylamide ethyl sulfate salt, dimethylaminopropyl methacrylamide sulfuric acid salt, dimethylaminopropyl methacrylamide hydrochloric acid salt, dimethylaminopropyl methacrylamide sulphamic acid salt, or dimethylaminopropyl methacrylamide citric acid salt.

14. The drilling fluid of claim 1 wherein said aqueous phase comprises one or more of fresh water, brine, or a water soluble compound.

15. The drilling fluid of claim 1 further comprising one or more of a viscosifier, fluid loss additive, shale swelling inhibitor, defoamer, bactericide, lost circulation material, weighting agent, clay control additive, or a bridging agent.

16. The drilling fluid of claim 15 wherein said viscosifier comprises xanthan gum, guar gum, hydroxyethyl cellulose, carboxymethyl cellulose, hydroxypropyl guar gum, hydroxypropyl carboxymethyl guar gum, locust bean gum or starch.

17. The drilling fluid of claim 15 wherein said fluid loss additive comprises carboxymethyl starch, carboxymethyl cellulose, derivatized starch or carboxymethyl guar.

18. The drilling fluid of claim 1 wherein the concentration of the polymer in the drilling fluid is up to 20% w/w of the drilling fluid.

19. The drilling fluid of claim 18 wherein the concentration of the polymer in the drilling fluid is 0.005% to 1% w/w of the drilling fluid.

20. The drilling fluid of claim 1 wherein the pH of the drilling fluid is about 1 to about 13.

21. The drilling fluid of claim 20 wherein the pH of the drilling fluid is 4 to 11.

22. A mixture or pre-mix kit of components for preparing a drilling fluid comprising at least one polymer comprising: a non-ionic polymer, a cationic polymer or a mixture thereof wherein the polymer comprises monomers comprising at least one of an amide or lactam functional group; and at least one drilling fluid additive comprising one or more of a viscosifier, fluid loss additive, shale swelling inhibitor, defoamer, bactericide, lost circulation material, weighting agent, clay control additive or a bridging agent.

23. The mixture or pre-mix kit of claim 22, wherein said non-ionic polymer has the general formula I: 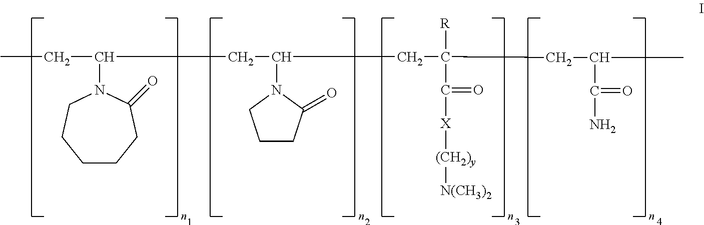
wherein:
R is hydrogen or an alkyl group optionally containing at least one heteroatom comprising oxygen or nitrogen, wherein said alky group is saturated or unsaturated, and is linear, branched or cyclic as permitted by the length of said group;
n₁, n₂, n₃ and n₄ are each independently selected from 0 to 1,000,000 and at least one of n₁, n₂, n₃ and n₄ has a value greater than zero;
X is nitrogen or oxygen; and
y is 2 or 3.

24. The mixture or pre-mix kit of claim 22, wherein said cationic polymer has the general formula II: 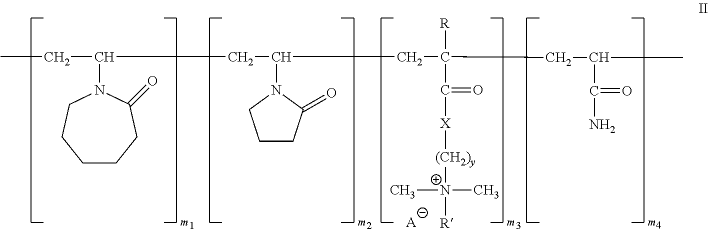
wherein:
R and R′ are independently hydrogen or an alkyl group optionally containing at least one heteroatom comprising oxygen or nitrogen, wherein said alky group is saturated or unsaturated, and is linear, branched or cyclic as permitted by the length of said group;
m₁, m₂, m₃ and m₄ are each independently selected from 0 to 1,000,000 and at least one of m₁, m₂, m₃ and m₄ has a value greater than zero;
X comprises nitrogen or oxygen;
y is 2 or 3; and
A is chloride, bromide, sulfate, methyl sulfate or ethyl sulfate.

25. The mixture or pre-mix kit of claim 22, wherein said cationic polymer has the formula III: 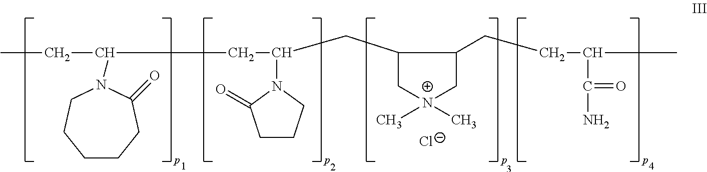
wherein:
p₁, p₂, p₃, p₄ are each independently selected from 0 to 1,000,000 and at least one of p₁, p₂, p₃ and p₄ has a value greater than zero.

26. A polymer having the general formula I, II or III: 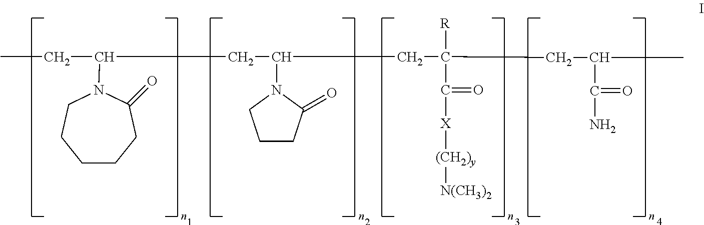
wherein:
n₁, n₂, n₃ and n₄ are each independently selected from 0 to 1,000,000 and at least one of n₁, n₂, n₃ and n₄ has a value greater than zero;
X is nitrogen or oxygen; and
y is 2 or 3; 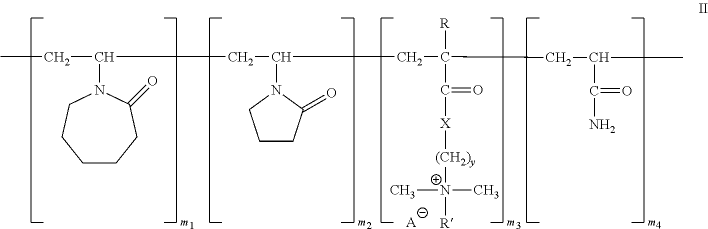
wherein:
m₁, m₂, m₃ and m₄ are each independently selected from 0 to 1,000,000 and at least one of m₁, m₂, m₃ and m₄ has a value greater than zero;
X comprises nitrogen or oxygen;
y is 2 or 3; and
A is chloride, bromide, sulfate, methyl sulfate or ethyl sulfate; 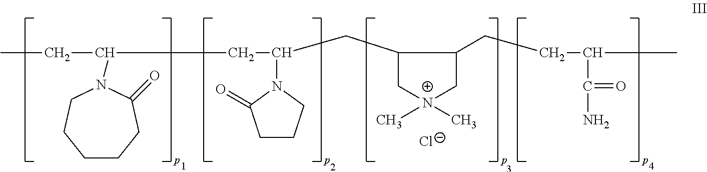
wherein:
p₁, p₂, p₃, p₄ are each independently selected from 0 to 1,000,000 and at least one of p₁, p₂, p₃ and p₄ has a value greater than zero;
and wherein in the above formulae I and II, R and R′ are independently hydrogen or an alkyl group optionally containing at least one heteroatom comprising oxygen or nitrogen, wherein said alky group is saturated or unsaturated, and is linear, branched or cyclic as permitted by the length of said group.

27. The polymer of claim 25 wherein said alkyl group is a C₁ to C₁₂, C₁ to C₆ or C₁ to C₃ alkyl group.
